(19) United States
(12) Patent Application Publication
(10) Pub. No.: US 2024/0121505 A1
(43) Pub. Date: Apr. 11, 2024

(54) IMAGE SYNTHESIS APPARATUS AND IMAGE SYNTHESIS METHOD

(71) Applicant: NIPPON TELEGRAPH AND TELEPHONE CORPORATION, Tokyo (JP)

(72) Inventors: Hiroya ONO, Musashino-shi, Tokyo (JP); Toshihito FUJIWARA, Musashino-shi, Tokyo (JP); Tatsuya FUKUI, Musashino-shi, Tokyo (JP)

(73) Assignee: NIPPON TELEGRAPH AND TELEPHONE CORPORATION, Tokyo (JP)

(21) Appl. No.: 18/276,225

(22) PCT Filed: Feb. 18, 2021
(86) PCT No.: PCT/JP2021/006139

§ 371 Date: Aug. 7, 2023

(51) Int. Cl. H04N 23/66; H04N 5/262

(52) U.S. Cl. CPC H04N 23/66; H04N 5/2624

(57) ABSTRACT

An object of the present disclosure is to reduce a delay time from input of a plurality of videos to output of combined videos.

The present disclosure is a video combining device detecting a time deviation between a timing of a frame of each video and a predetermined timing when videos from a plurality of cameras are combined into one screen, giving an instruction for an imaging frame rate to the cameras such that the time deviation is reduced, and combining the videos from the plurality of cameras into one screen and outputting the combined videos.

### TECHNICAL FIELD

The present invention relates to a video combining device and a video combining method for combining videos from a plurality of cameras into one screen.

### BACKGROUND ART

In recent years, many video devices have been used. Although there is a difference in physical video signal characteristics or definition of a control signal depending on a standard, a video device transmits one screen by using a time corresponding to a frame rate thereof. For example, in a case of a video signal of 60 frames per second (hereinafter, 60 frames per second (fps)), a video of one screen is transmitted for 1/60 seconds, that is, about 16.8 milliseconds.

A video signal for one frame is illustrated in FIG. 1. In FIG. 1, the reference numeral 51 denotes a video signal for one frame, the reference numeral 52 denotes blanking, the reference numeral 53 denotes a scanning line, and the reference numeral 54 denotes a display screen. In this video signal 51, the scanning line 53 scans the screen every line in a horizontal direction, and sequentially moves downward. This scanning includes the blanking 52 or overhead information/signals in addition to the display screen 54. The blanking 52 may include information other than video information, such as control information and audio information (refer to, for example, Non Patent Literature 1).

As a method of using these videos, there is a mode in which a plurality of cameras are displayed on fewer monitors than the number of cameras, in a video conference. For example, FIG. 2 illustrates a mode in which videos from a plurality of cameras are displayed on fewer monitors than the number of cameras. In FIG. 2, the reference numeral 200 denotes a video combining device, the reference numeral 20 denotes a camera, and the reference numeral 22 denotes a monitor. Videos from the four cameras 20 are combined into one screen by the video combining device 200 and displayed on the monitor 22.

Normally, timings of the videos captured by the respective cameras are not synchronized, and timings of other videos to be combined are different. Therefore, the videos are temporarily buffered in a memory or the like and then combined. Consequently, a delay occurs in the output of the combined videos. The occurrence of the delay will be described with reference to FIG. 3. FIG. 3 is a timing chart illustrating video combination in which four videos having different timings are input, combined into one screen, and output. A case of a mode in which all videos are read, combined, and output is considered. Assuming that a frame time is Tf and a combining process time is Tp, the maximum delay time from the first video input to the video output is 2Tf+Tp. For example, considering a video of 60 fps, there is a possibility that a delay corresponding to time of 2 frames or more, that is, 34.5 ms or more is included in the combined videos.

Assuming that an ensemble concert or the like is performed at a remote place or the like by using a video conference system that performs such video combination, a delay related to the video combination greatly impairs the feasibility. For example, in a case of a song with 120 beats per minute (hereinafter, 120 beats per minute (BPM)), the time of one beat is 60/120 seconds=500 milliseconds. When it is necessary to match this with 5% accuracy, it is necessary to suppress a delay until a camera captures a video and displays the video at 500 ms×0.05=25 ms or less.

In practice, it is necessary to include other delays such as a video processing time in a camera, a display time on a monitor, and a time related to transmission, in addition to processing related to combination, until the camera captures a video and displays the video. Consequently, in the related art, it is difficult to perform cooperative work in a case where a timing is important, for example, in a case where an ensemble concert or the like is performed by watching videos in remote places.

When videos from a plurality of cameras at a plurality of bases are combined with respect to a low delay request, a technique of reducing a delay time from input of a plurality of videos to output of combined videos is effective.

As a method of combining videos with a low delay, there is a method of supplying a trigger for giving an instruction for an appropriate imaging timing to each camera from a video combining device or an external device such that timings of frames of videos from the cameras are aligned (refer to, for example, Non Patent Literature 2). When the trigger mode of the genIcam standard is used, it is possible to cause a camera to capture a video at a desired timing by supplying an electrical trigger as a rectangular wave to a gigE camera or the like.

The method in Non Patent Literature 2 is illustrated in FIG. 4. FIG. 4 is a diagram for describing a mode in which videos from a plurality of cameras are displayed on fewer monitors than the number of cameras. In FIG. 4, the reference numeral 210 denotes a video combining device, the reference numeral 20 denotes a camera, and the reference numeral 22 denotes a monitor. Each camera 20 captures a video in accordance with an imaging trigger from the video combining device 210. The video combining device 210 combines videos from the respective cameras 20 into one screen, and outputs the combined screen to the monitor 22. A timing chart for the video combination is illustrated in FIG. 5. Assuming that a frame time is Tf and a processing time is Tp, the maximum delay time from the first video input to the video output is Tf+Tp.

### CITATION LIST

### Non Patent Literature

Non Patent Literature 1: VESA and Industry Standards and Guidelines for Computer Display Monitor Timing (DMT), Version 1.0, Rev.13, Feb. 8, 2013
Non Patent Literature 2: EMVA, “GenICam Standard Features Naming Convention Version 2.3, 5. 26. 2016, https://www.emva.org/wp-content/uploads/GenICam_SFNC_2_3.pdf

### SUMMARY OF INVENTION

### Technical Problem

FIG. 6 illustrates a mode in which the method in Non Patent Literature 2 is applied to a video conference system connecting remote places. FIG. 6 is a diagram for describing a mode in which videos from a plurality of cameras are displayed on fewer monitors than the number of cameras. In FIG. 6, the reference numeral 210 denotes a video combining device, the reference numeral 20 denotes a camera, the reference numeral 21 denotes a communication network, and the reference numeral 22 denotes a monitor. As illustrated in FIG. 6, the communication network 21 for transmitting a signal is interposed between the camera 20 and the video combining device 210. When a trigger signal is transmitted via such a communication network, distortion of the trigger signal occurs according to transmission delay fluctuation of the communication network. When an average one-way transmission delay of the communication network is t, considering the influence of an additional delay Δt generated due to the fluctuation, an additional delay of 2Δt occurs at the maximum. A timing chart for the video combination is illustrated in FIG. 7. Assuming that a frame time is Tf, a processing time is Tp, and an additional delay is 2Δt, the maximum delay time from the first video input to the video output is Tf+Tp+2Δt.

Even in the method in Non Patent Literature 2, when a plurality of videos at a plurality of bases are combined via a communication network, a large delay cannot be avoided in the time from the input of a plurality of videos to the output of combined videos. Thus, it is necessary to reduce a delay time from the input of a plurality of videos to the output of combined videos.

Therefore, an object of the invention of the present disclosure is to reduce a delay time from the input of a plurality of videos to the output of combined videos.

### Solution to Problem

In the video combining device of the present disclosure, frequency control of an imaging frame rate is performed on each camera such that timings of videos from a plurality of cameras match each other.

Specifically, a video combining device of the present disclosure:
detects a time deviation between a timing of a frame of each video and a predetermined timing when videos from a plurality of cameras are combined into one screen;
gives an instruction for an imaging frame rate to the cameras such that the time deviation is reduced; and
combines the videos from the plurality of cameras into one screen and outputs the combined videos.

Specifically, in the video combining device of the present disclosure,
the frame rate for which the instruction is given is a value separated from a video combination frame rate at which the videos are combined by a certain value.

Specifically, in the video combining device of the present disclosure,
the frame rate for which the instruction is given is a value separated from a video combination frame rate at which the videos are combined by a value corresponding to the time deviation.

Specifically, in the video combining device of the present disclosure,
the instruction for the frame rate is periodically given.

Specifically, in the video combining device of the present disclosure,
when the time deviation is equal to or less than a certain value, the frame rate for which the instruction is given is fixed.

Specifically, in the video combining device of the present disclosure,
the predetermined timing is a combining process start timing.

Specifically, in the video combining device of the present disclosure,
the combining process start timing is an average value of frame end timings of the videos from the plurality of cameras.

In a video combining method of the present disclosure, frequency control of an imaging frame rate is performed on each camera such that timings of videos from a plurality of cameras match each other.

Specifically, the video combining method of the present disclosure includes:
detecting a time deviation between a timing of a frame of each video and a predetermined timing when videos from a plurality of cameras are combined into one screen;
giving an instruction for an imaging frame rate to the cameras such that the time deviation is reduced; and
combining the videos from the plurality of cameras into one screen and outputting the combined videos.

### Advantageous Effects of Invention

According to the video combining device or the video combining method of the present disclosure, it is possible to reduce a delay time from the input of a plurality of videos to the output of combined videos.

### BRIEF DESCRIPTION OF DRAWINGS

FIG. 1 is a diagram illustrating a video signal for one frame.

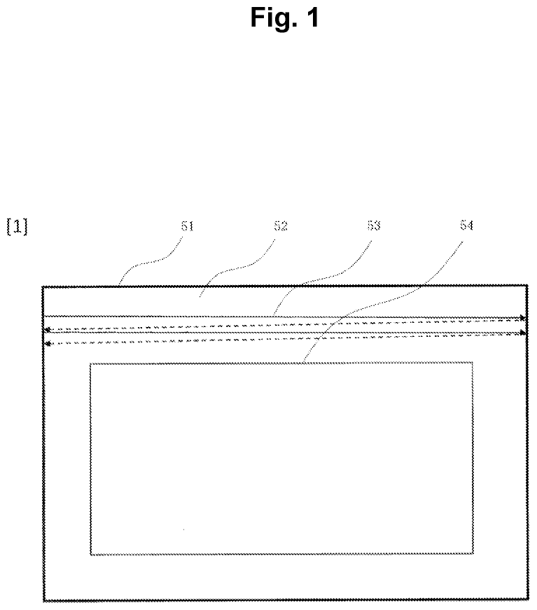

FIG. 2 is a diagram for describing a mode in which videos from a plurality of cameras are displayed on fewer monitors than the number of cameras.

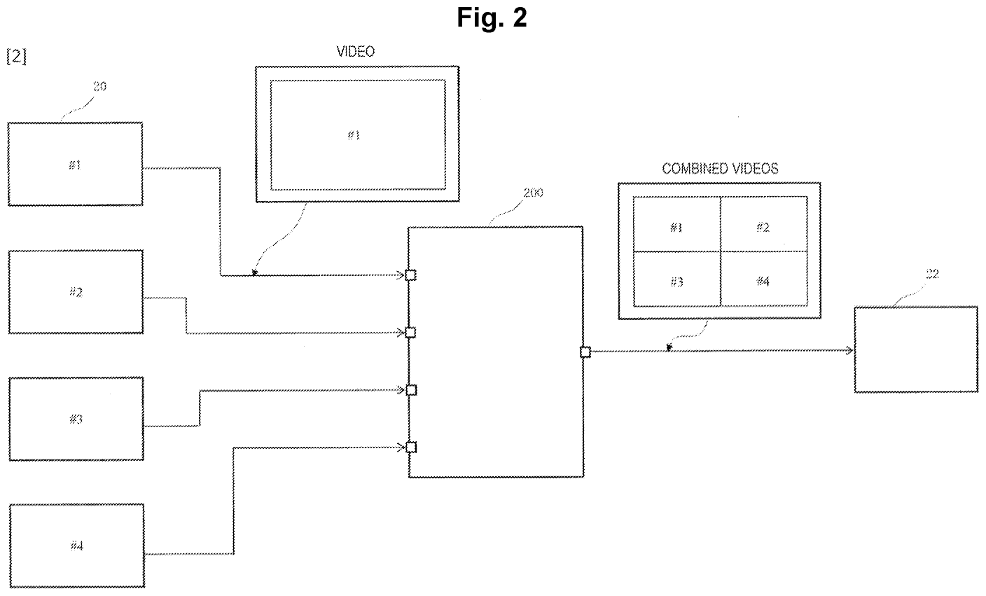

FIG. 3 is a timing chart for video combination.

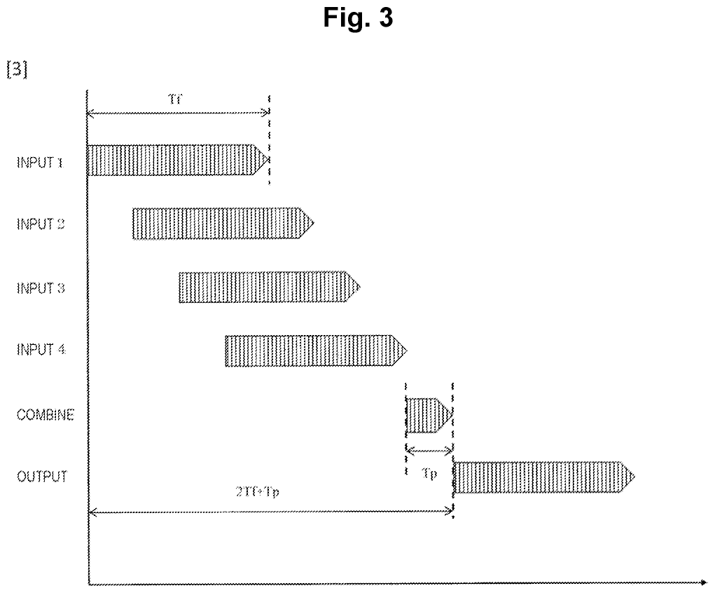

FIG. 4 is a diagram for describing a mode in which videos from a plurality of cameras are displayed on fewer monitors than the number of cameras.

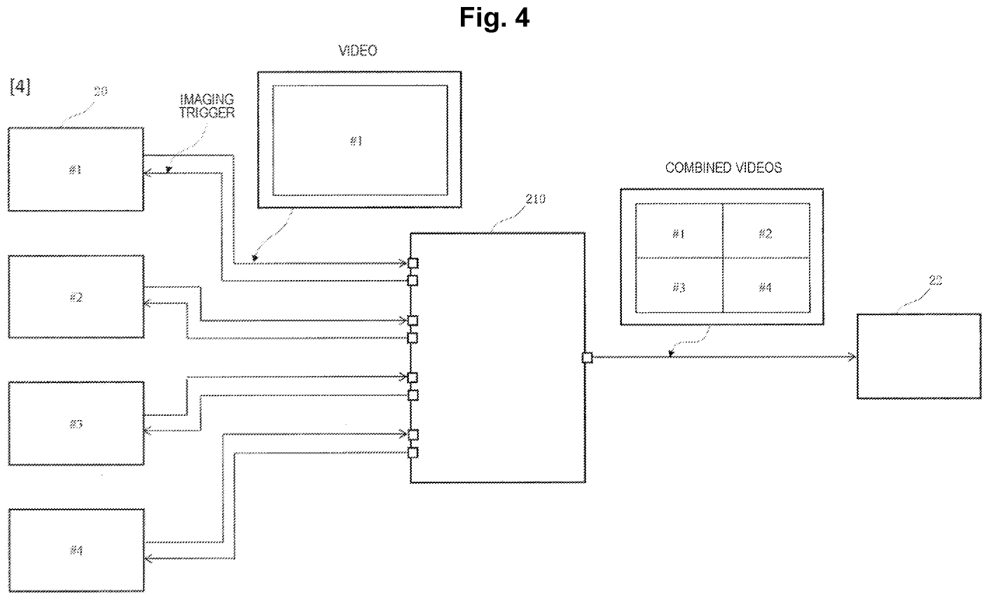

FIG. 5 is a timing chart for video combination.

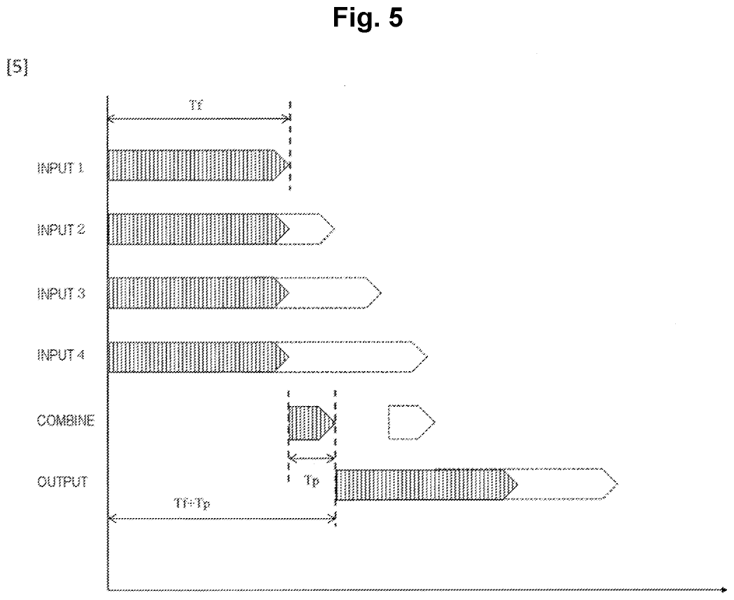

FIG. 6 is a diagram for describing a mode in which videos from a plurality of cameras are displayed on fewer monitors than the number of cameras.

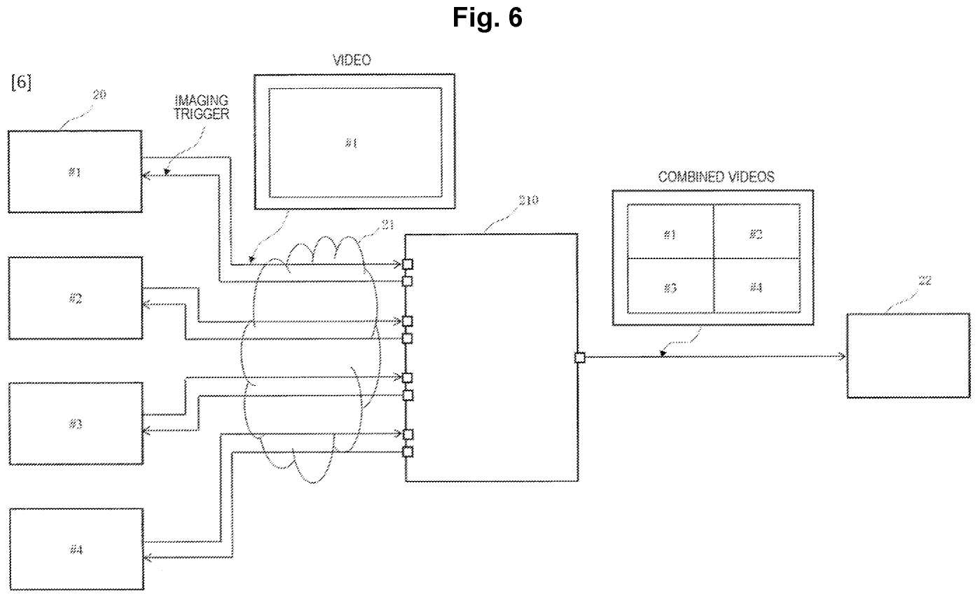

FIG. 7 is a timing chart for video combination.

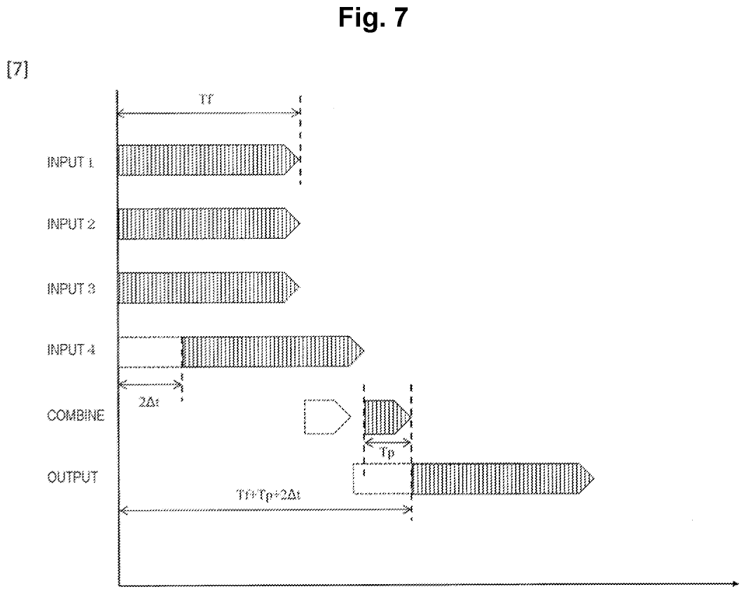

FIG. 8 is a diagram for describing a mode of the present disclosure in which videos from a plurality of cameras are displayed on fewer monitors than the number of cameras.

FIG. 9 is a timing chart for video combination.

FIG. 10 is a timing chart for video combination.

FIG. 11 is a diagram illustrating a configuration of a video combining device.

FIG. 12 is a diagram for describing a control method.

FIG. 13 illustrates an example of a control function of a frame rate to be determined.

FIG. 14 is a diagram for describing a control method.

FIG. 15 is a diagram for describing a control method.

### DESCRIPTION OF EMBODIMENTS

Hereinafter, embodiments of the present disclosure will be described in detail with reference to the drawings. The present disclosure is not limited to the embodiments described below. These embodiments are merely an example, and the present disclosure can be carried out in forms with various modifications and improvements on the basis of knowledge of those skilled in the art. Note that constituents having the same reference numerals in the present specification and the drawings indicate the same constituents.

A video combining device of the present disclosure performs frequency control of an imaging frame rate of a camera such that a time deviation between timings of a plurality of videos and a predetermined timing decreases when videos from a plurality of cameras are combined into one screen.

The frequency control of an imaging frame rate of a camera can be executed on a camera that supports, for example, gigEvision or USBVision by using a control interface such as GenICam. Although an available frequency is selective for a camera that supports HDMI, the present disclosure can be applied depending on a resolution or a frame rate.

Here, gigEvision is a standard formulated by the Automated Imaging Association (AIA) in order to control a camera or transmit a captured video signal to a personal computer or the like via the Internet.

USBVision is a standard formulated by the AIA in order to transfer video data from a camera to a user buffer.

GenICam is a software interface standard formulated by the European Machine Vision Association (EMVA) in order to set a wide range of standard interfaces end-to-end regardless of the type of camera and a format of video transmission.

High Definition Multimedia Interface (HDMI) is a transmission standard formulated by seven companies for AV devices.

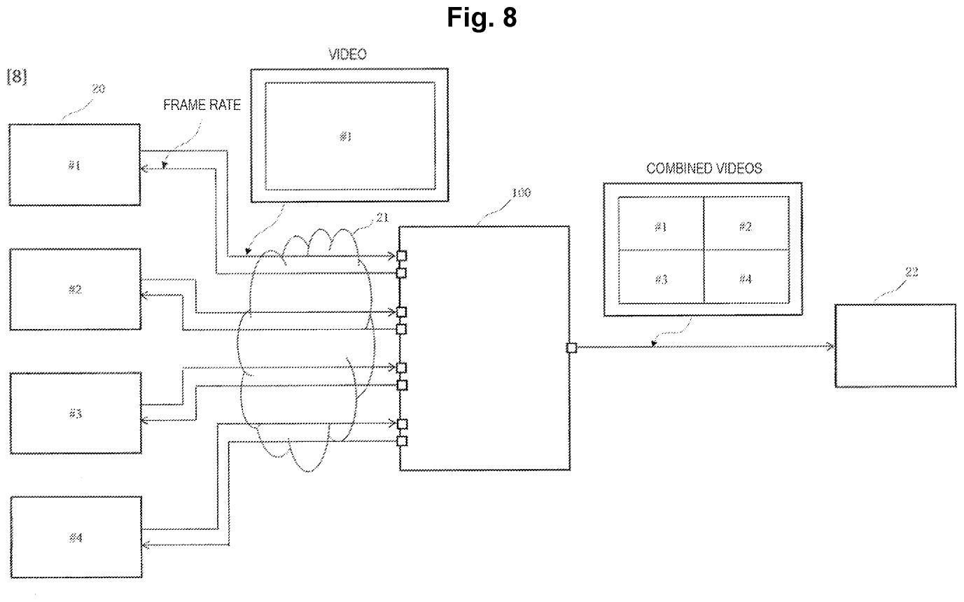

FIG. 8 illustrates a mode of the present disclosure in which videos from a plurality of cameras are displayed on fewer monitors than the number of cameras. In FIG. 8, the reference numeral 100 denotes a video combining device of the present disclosure, the reference numeral 20 denotes a camera, the reference numeral 21 denotes a communication network, and the reference numeral 22 denotes a monitor. The video combining device 100 combines videos input from a plurality of cameras 20 via the communication network 21 into one screen, and outputs the screen to the monitor 22. In FIG. 8, the video combining device 100 has four input channels, but the number of inputs may be any number.

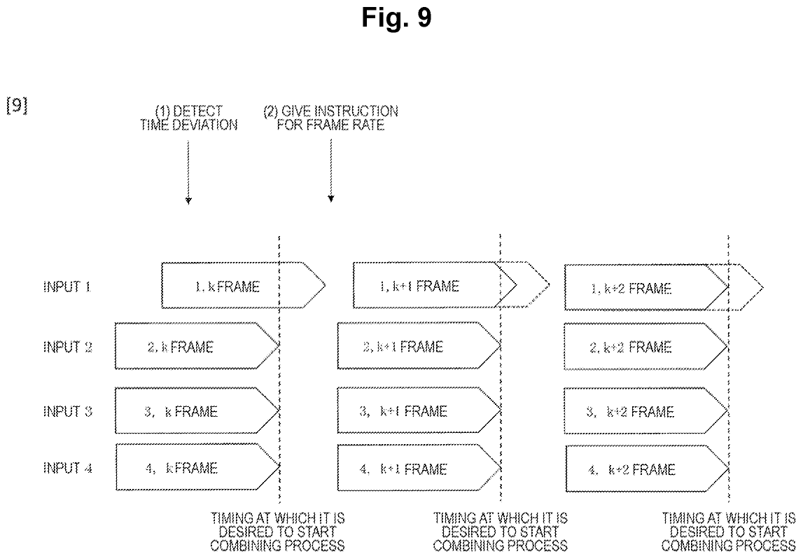

FIG. 9 illustrates a timing chart in which video combining device 100 of the present disclosure combines videos. Although four input channels are illustrated in FIG. 9, the number of input channels is not limited thereto. In FIG. 9, “i, k frame” represents a k-th frame of a video input to an i-th input channel. The same applies to the following description. In a case where a timing of the k-th frame of the video input to the i-th input channel does not match a predetermined timing, for example, a timing at which it is desired to start a combining process in FIG. 9, the video combining device 100 detects a time deviation of these timings ((1) in FIG. 9), and instructs the camera 20 connected to the i-th input channel to capture a video at a frame rate slightly different from an output frame rate of the video combining device 100 ((2) in FIG. 9). Consequently, the time deviation gradually decreases to “i, k+1 frame” and “i, k+2 frame”.

The video combining device 100 has a video combination frame rate at which videos are combined according to a standard frame rate. For example, for a camera group of which a standard frame rate is nominal 120 fps, the video combining device 100 sets a video combination frame rate to 120 fps. In FIG. 9, when it is detected that a timing of the k-th frame of the video input to the i-th input channel of the cameras 20 is delayed from a timing at which the combining process is desired to be started, with respect to the group of cameras 20 of which the standard frame rate is nominal 120 fps, the video combining device 100 instructs the camera 20 connected to the i-th input channel to capture a video at a frame rate of (120+Δf) fps separated from the video combination frame rate by a certain value. When it is detected that the timing of the k-th frame of the video input to the i-th input channel is advanced from the timing at which the combining process is desired to be started, the video combining device 100 instructs the camera 20 connected to the i-th input channel to capture a video at a frame rate of (120−Δf) fps separated from the video combination frame rate by a certain value. The time deviation such as frame timing delay or advance is ½ or less of a frame length. This is because, when the time deviation is ½ or more of a frame, the previous frame or the next frame is closer to the timing at which the combining process is desired to be started. When Δf=1 fps, a delay time that can be compensated per frame is 1/120-1/121=0.7 ms, and can be accurately controlled within the range of the control resolution defined by GenICam.

In the above description, a frame rate for which the instruction is a value separated from the video combination frame rate by a certain value, but may be separated from the video combination frame rate by a value of a variable amount. For example, a frame rate of a value separated from the video combination frame rate may be designated according to a time deviation between the timing of the k-th frame of the video input to the i-th input channel and the timing at which the combining process is desired to be started. Alternatively, if the time deviation is more than a predetermined value, a frame rate separated from the video combination frame rate by Δf may be designated, and if the time deviation is less than the predetermined value, a frame rate separated from the video combination frame rate by ½ Δf may be designated.

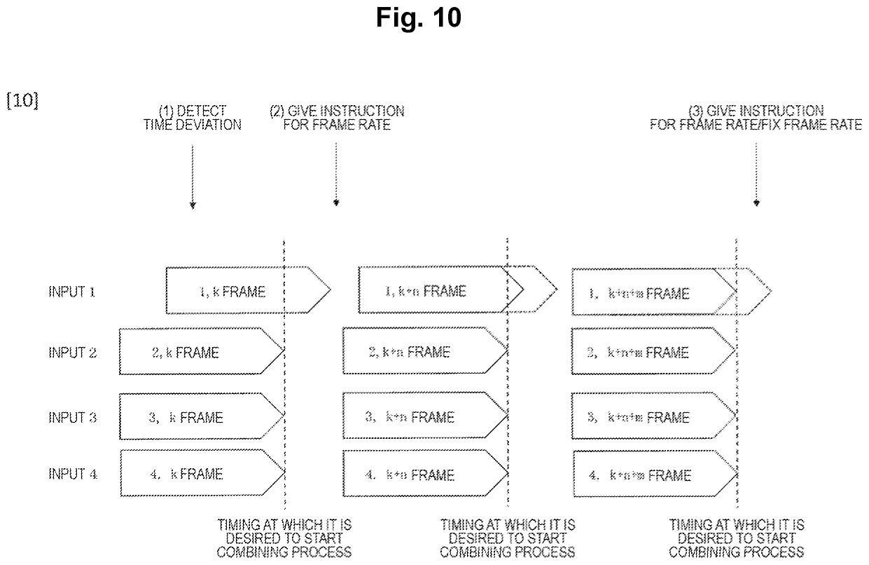

FIG. 10 illustrates a timing chart in which the video combining device 100 of the present disclosure combines videos. In FIG. 10, the video combining device 100 may constantly detect a time deviation between the timing of the k-th frame of the video input to the i-th input channel and the predetermined timing (constantly execute (1) of FIG. 10 for each frame), or may periodically detect (periodically execute (1) of FIG. 10 every several frames) in a constant cycle. The video combining device 100 may constantly give an instruction for a frame rate to the camera 20 connected to the i-th input channel (constantly execute (2) of FIG. 10 for each frame), or may periodically give the instruction in a constant cycle (periodically execute (2) of FIG. 10 every several frames).

In FIG. 10, if there is a time deviation between the timing of the k-th frame of the video input to the i-th input channel and the predetermined timing, the video combining device 100 may give an instruction for a new frame rate to the camera 20 (the upper part in (3) of FIG. 10). If a time deviation between a timing of the (k+n+m)-th frame of the video input to the i-th input channel and the predetermined timing is equal to or less than a certain value, a frame rate for which the instruction may be fixed to a combination frame rate (the lower part of FIG. 10 (3)), or a new frame rate may not be designated.

If a frame rate for which the instruction is fixed or a new frame rate is not designated, additional control is not required as long as a setting of a related device or characteristics of a communication network are not changed after the fixing of an imaging frame rate of the camera 20 is completed, and an amount of generated communication can be minimized.

As described above, in the video combining device and the video combining method of the present disclosure, only a frame rate is controlled without controlling an imaging timing of the camera, and thus it is difficult to be influenced by transmission delay fluctuation of a control signal. Even if a timing of giving an instruction for a frame rate to the camera is delayed, the necessary time until the fixation of the frame rate is completed only extends. If an instruction for a frame rate is given to the camera and thus a time deviation continues to be reduced, excessive control is eventually performed, and delay or advance of the time deviation increases in an opposite direction. However, an instruction for a frame rate may be given in a short period. For example, in a case where it is desired to guarantee a time deviation in a timing at 3.5 ms or less, if an imaging frame rate of 121 fps is designated with respect to the combining process frame rate of 120 fps, since a delay time that can be compensated per frame is 0.7 ms, imaging may be performed at 121 fps for 5 frames, and then the combining process frame rate of 120 fps may be designated. Even if a signal for designating a frame rate has delay fluctuation for one frame (8.3 ms) due to the communication network, a delay reaching the video combining device is about 0.7 ms.

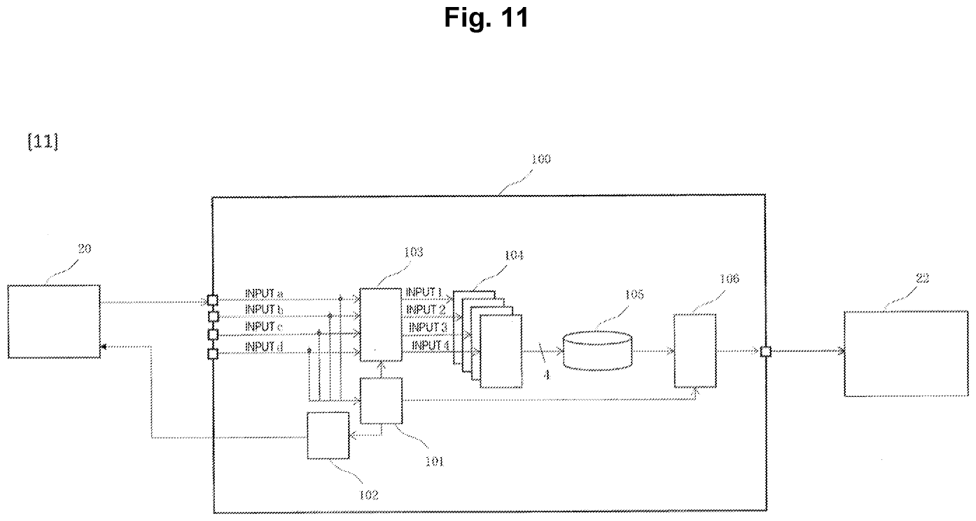

FIG. 11 illustrates a configuration of a video combining device of the present disclosure. In FIG. 11, the reference numeral 100 denotes a video combining device, the reference numeral 101 denotes a time deviation detection circuit, the reference numeral 102 denotes a frame rate calculation circuit, the reference numeral 103 denotes a crossbar switch, the reference numeral 104 denotes an up-down converter, the reference numeral 105 denotes a buffer, the reference numeral 106 denotes a pixel combining circuit, the reference numeral 20 denotes a camera, the reference numeral 21 denotes a communication network, and the reference numeral 22 denotes a monitor. In FIG. 11, the number of inputs of the video combining device 100 is four, but any number of inputs may be used.

The time deviation detection circuit 101 detects a time deviation between a timing of a frame of a video from the camera 20 and a predetermined timing. The frame rate calculation circuit 102 calculates an imaging frame rate of the camera 20 such that the time deviation detected by the time deviation detection circuit 101 is reduced, and gives an instruction for the calculated frame rate to the camera 20. The crossbar switch 103 rearranges the video inputs in any order and outputs the rearranged video inputs. The time deviation detection circuit 101 may have a function of designating rearrangement. The up-down converter 104 increases or decreases the number of pixels of the video to any size. The crossbar switch 103 and the up-down converter 104 may be connected to the inputs in the order reverse to the order in FIG. 11. The buffer 105 buffers the input video. Instead of the crossbar switch 103, the buffer 105 may have a function of freely switching the order of a video to be output. The pixel combining circuit 106 reads and outputs the video from the buffer 105. The pixel combining circuit 106 may have a function of adding any control signal to a blanking portion of a screen.

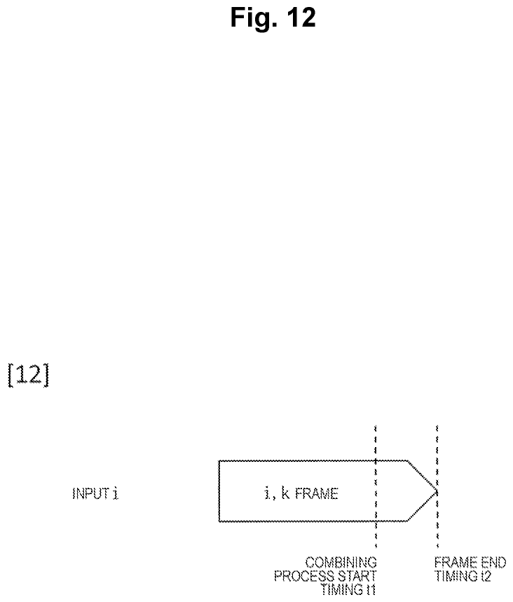

A predetermined timing serving as a base point of a time deviation detected by the time deviation detection circuit 101 may be a combining process start timing of the video combining device 100. Control in a case where an end timing of the k-th frame of the video captured by the i-th camera has a time deviation from a combining process start timing of the video combining device 100 will be described with reference to FIG. 12. In FIG. 12, the time deviation detection circuit 101 records a combining process start timing t1. An end timing t2 of the k-th frame of the video captured by the i-th camera is recorded, and a time deviation from the combining process start timing t1 is detected.

As an example of the combining process start timing, an average value of frame end timings of the videos from the plurality of cameras may be used. For example, in a case where a time stamp of an imaging timing is recorded in a video and fluctuation of a time difference between time stamps recorded in videos acquired from a plurality of cameras is large in a gigE camera, an average value of frame end timings of videos from the plurality of cameras may be derived according to the following formula.

Average value of frame end timing=(1/N)*Σ(t2(k)−t1(k))

Here, t1(0)=t1(0)+n*1/f0

N is the number of videos from which the average value of the frame end timings is derived
t1(k) is a combining process start timing for the k-th frame
t1(k) is an end timing of the k-th frame
f0 is a video combination frame rate

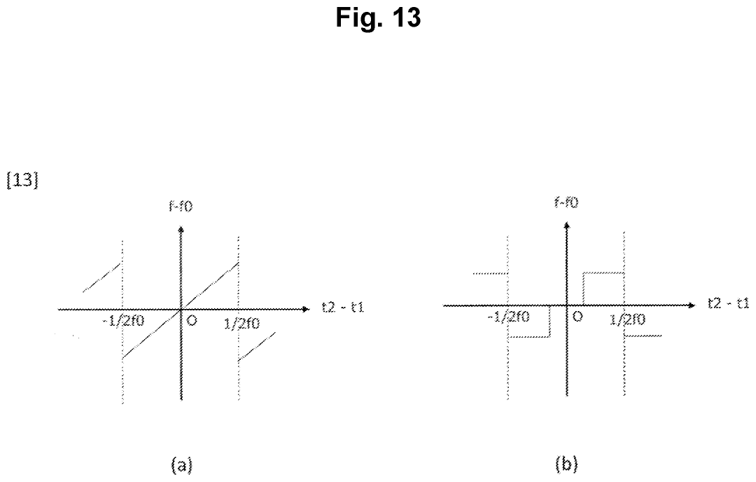

On the basis of the time deviation detected by the time deviation detection circuit 101, the frame rate calculation circuit 102 calculates a frame rate f such that the time deviation is reduced. An example of a control function of a frame rate to be calculated is illustrated in FIG. 13. When the time deviation is |t2−t1|>1/(2*f0), if a frame of a video from the camera to be compared is the next frame or the previous frame, the definition of the range of |t2−t1|>1/(2*f0) becomes unnecessary.

In FIG. 13(a), control is performed such that the frame rate is increased at t2−t1>0 in the range of |t2−t1|<1/(2*f0), and control is performed such that the frame rate is decreased at t2−t1<0. A magnitude of the difference (f−f0) between the frame rate f to be determined and the video combination frame rate f0 is a value corresponding to the absolute value |t2−t1| of the time deviation, and the convergence of the time deviation is accelerated. This control function may not be linear. For example, the control function may have a stepped shape.

The control in FIG. 13(b) is the same as the control in FIG. 13(a) in that control is performed such that the frame rate is increased at t2−t1>0 in the range of |t2−t1|<1/(2*f0), and control is performed such that the frame rate is decreased at t2−t1<0. In the control function is given such that the range in which the absolute value |t2−t1| of the time deviation is small, a frame rate for which the instruction is given to the camera 20 is the same as the video combination frame rate, and in the range in which the absolute value |t2−t1| of the time deviation is large, a magnitude of the difference (f−f0) between the frame rate f to be determined and the video combination frame rate f0 is a constant value.

Even if there is an error between a clock of the video combining device and a clock of the camera, the video combining device and the video combining method of the present disclosure can minimize the time deviation (t2−t1). In this case, the control function does not necessarily pass through the origin 0. This is because, when there is an error between the clock of the video combining device and the clock of the camera, the combining process start timing and the frame end timing are not completely synchronized with each other at f−f0=0.

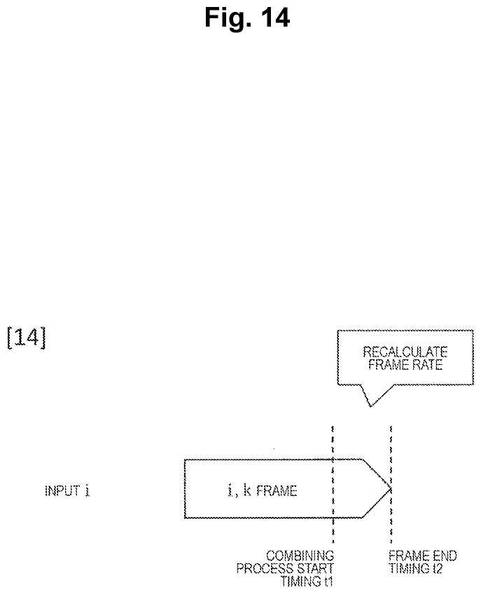

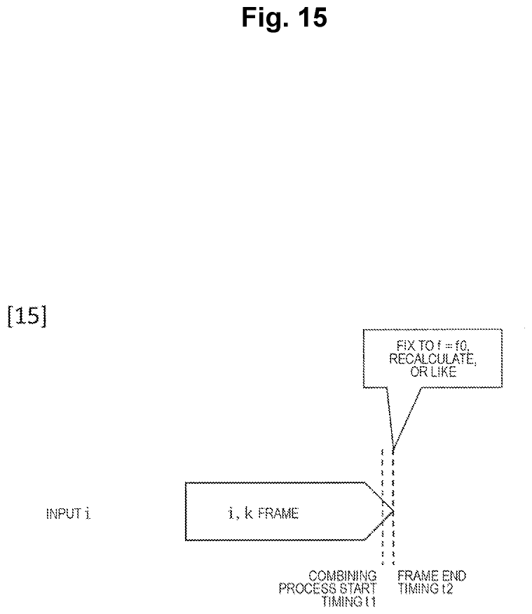

As illustrated in FIG. 14, in a case where the time deviation (t2−t1) is still large, the frame rate calculation circuit 102 recalculates and determines the frame rate f. As illustrated in FIG. 15, in a case where the time deviation (t2−t1) decreases, the frame rate calculation circuit 102 may fix or recalculate the frame rate f.

In a case where there is a time deviation and the frame rate for which the instruction f is set to a value separated from the combining process frame rate f0 by a constant value |f−f0|, the frame rate calculation circuit 102 may calculate an expected time T at which the time deviation is minimized by using the difference (f−f0) between the determined frame rate f and the video combination frame rate f0 and the time deviation (t2−t1). The expected time T may be calculated by using the following formula.

T=(t2−t1)*(1/f0)/|1/f−1/f0|

The frame rate calculation circuit 102 may give an instruction for a constant frame rate until the expected time T elapses, and recalculate the frame rate after the expected time T elapses.

The frame rate calculation circuit 102 gives an instruction for the determined frame rate to each camera 20. Each camera 20 captures a video at the designated frame rate.

As described above, the video combining device and the video combining method of the present disclosure can reduce a delay time from the input of a plurality of videos to the output of combined videos. Even if fluctuation occurs in timings of frames of videos from a plurality of cameras at remote places, a delay time from the input of a plurality of videos to the output of combined videos can be reduced. Even if there is an error between a clock of the video combining device and a clock of the camera, by controlling a frame rate, a delay time from the input of a plurality of videos to the output of combined videos can be reduced.

### INDUSTRIAL APPLICABILITY

The present disclosure can be applied to information and communication industries.

### REFERENCE SIGNS LIST

100 Video combining device
101 Time deviation detection circuit
102 Frame rate calculation circuit
103 Crossbar switch
104 Up-down converter
105 Buffer
106 Pixel combining circuit
200 Video combining device
210 Video combining device
20 Camera
21 Communication network
22 Monitor
51 Video signal for one frame
52 Blanking
53 Scanning line
54 Display screen

1. A video combining device
detecting a time deviation between a timing of a frame of each video and a predetermined timing when videos from a plurality of cameras are combined into one screen;
giving an instruction for an imaging frame rate to the cameras such that the time deviation is reduced; and
combining the videos from the plurality of cameras into one screen and outputting the combined videos.

2. The video combining device according to claim 1, wherein the frame rate for which the instruction is given is a value separated from a video combination frame rate at which the videos are combined by a certain value.

3. The video combining device according to claim 1, wherein the frame rate for which the instruction is given is a value separated from a video combination frame rate at which the videos are combined by a value corresponding to the time deviation.

4. The video combining device according to claim 1, wherein the instruction for the frame rate is periodically given.

5. The video combining device according to claim 1, wherein when the time deviation is equal to or less than a certain value, the frame rate for which the instruction is given is fixed.

6. The video combining device according to claim 1, wherein the predetermined timing is a combining process start timing.

7. The video combining device according to claim 6, wherein the combining process start timing is an average value of frame end timings of the videos from the plurality of cameras.

8. A video combining method comprising:
detecting a time deviation between a timing of a frame of each video and a predetermined timing when videos from a plurality of cameras are combined into one screen;
giving an instruction for an imaging frame rate to the cameras such that the time deviation is reduced; and
combining the videos from the plurality of cameras into one screen and outputting the combined videos.
